(19) United States
(12) Patent Application Publication
(10) Pub. No.: US 2013/0303024 A1
(43) Pub. Date: Nov. 14, 2013

(54) Safety Electrical Interconnect

(71) Applicant: Kyo Nagase Rapp, Lake Forest, CA (US)

(72) Inventor: Kyo Nagase Rapp, Lake Forest, CA (US)

(21) Appl. No.: 13/467,595

(22) Filed: May 9, 2012

(51) Int. Cl. H01R 13/66

(52) U.S. Cl. 439/620.21

(57) ABSTRACT

The invention is a safety electrical interconnect that mitigates shock risk, it adapts into standard electrical sockets, outlets or electrical wiring; it conceals electrically energized contacts yet is capable of transferring electrical energy between at least two parts inductively. A first part of the invention is capable of being plugged directly into a standard electrical socket or outlet using a plurality of prongs or pins protruding from at least a first surface. This first part is capable of passing electrical energy wirelessly using inductive transformer action when connected to one or more second parts of the invention. These second parts of the invention have one or more female connections capable of receiving prongs or pins from an electrical appliance or machine plug.

### BACKGROUND OF INVENTION

### Field of Invention

Conventional Electrical Outlets and Interconnects:

Household and industrial power outlets in the USA frequently contain one or more sockets into which standard electrical plugs are plugged into every day. Each socket has what appear to be two or three holes; each hole contains an electrical connection, and each such socket forms a “female” electrical receptacle. Even though the electrical connections in these holes cannot be touched on the outside surface of the socket or outlet, they may be contacted with a pointy probe or thin knife, and present a risk of shock to curious children probing into these holes with an electrically conductive probe. Electrical shocks may also occur when an electrical plug is partially plugged into a socket; if a prong contacts a hot electrical wire and a person touches an exposed portion of that prong the person may receive a strong electrical shock. These outlets and sockets despite their convenience are thus dangerous to small curious children and adults who inadvertently come in contact with an electrically active wire.

In the instance where a household socket contains three electrical contacts one contact is hot, a second contact is neutral, and the third contact is Earth ground. The neutral contact is at a near Earth ground potential or voltage level; there should always be a low impedance or resistance path between earth ground and neutral. Standard building codes specify that the earth ground and neutral should be connected together at a single point in the household.

In the instance where two such contacts are provided per socket, one is hot and the other is a neutral that is at or near earth ground potential.

In either instance above the hot contact carries an AC voltage. In the USA the most common voltage is 110V-120V 60 hertz (the hot lead typically alternates from 0 volts to over 110 volts sixty times per second), and 220-240V AC 60 hertz electrical outlets or sockets are less common.

Because of this most household appliances and pieces of electrical equipment have a plug containing two or three electrically conductive prongs. Plugs of this sort are male electrically conductive prongs or pins; they are designed to be plugged into outlets, or sockets that commonly contain female electrical interconnections. These outlets or sockets are also called power receptacles or female electrical receptacles. They are designed to receive and make electrical interconnections between wires contained within the outlets or sockets and conductive prongs or pins from an electrical equipment plug. Plugging the prongs into an outlet/socket makes an electrical connection that powers the appliance. Typically an outlet contains one or more sockets, and a socket contains one or more female electrical connectors, and a plug makes electrical connection between each female electrical connector to a corresponding prong in a power cord.

Open sockets in an outlet can be a safety hazard to small children. A metal pin stuck into an open socket can directly connect a child to hazardous voltages with power enough to hurt or kill them.

The invention described within this disclosure prevents a child from being able to insert a pin, a knife, or other instrument into or across an electrical outlet or socket mitigating shock hazards to children and adults.

Other embodiments of this invention include those that are compatible with other power outlet-plug configurations, such as single phase or 3 phase 220V power outlets and plugs used in industrial and heavy duty household wiring, or in plug to plug power distribution systems.

Transformer Action, Inductive Power Transfer:

Transformers for transferring electrical energy have been made for over 100 years; they are an energy efficient and inexpensive way to transfer energy between one point and another without direct electrical interconnection between the points. This is because of transformers work through inductive power transfer.

A transformer includes at least two coils of wire in close proximity and usually includes a magnetic core around which the coils are wound. Power is transferred inductively from one coil to the other through alternating magnetic fields.

Transformers are used to distribute power through the power grid of countries throughout the world, and transformers are used within electronic appliances of all sorts, transformers are however not used to adapt household or industrial outlets to household or industrial equipment by adapting the direct electrical interconnections to interconnections without direct electrical connections.

The intent of this invention is to transmit power from household or industrial power outlets by adapting equipment plugs with direct electrical connections electrical appliance plugs into standard alternating current outlets or sockets; the invention described within this disclosure specifies transformer action used to distribute electrical power from a power outlet or socket to an appliance or to electronic equipment eliminating exposed electrical interconnections between a plug and an outlet or socket.

### BRIEF DESCRIPTION OF THE INVENTION

This invention includes at least two parts, Part 1 and Part 2, each of which contains an electrical interconnection and at least one inductive coil.

Part 1's electrical interconnection connects to standard electrical outlets or to electrical wiring; Part 1's inductive coil presents a non-electrically energized surface to which Part 2 can be physically attached. Part 1 is the equivalent of an electrical power outlet; yet it is an inductive power transfer outlet. Part 2 is the equivalent of an electrical power plug; yet it is an inductive power transfer plug. In a preferred embodiment of the invention Part 1 and Part 2 form an electrical transformer of independent parts joined to work as one to transfer power without exposed electrical contacts to touch or probe. Virtually every home in a household has wall outlets with exposed electrical connections that pose a danger to small children; a child can stick a conductive probe into a standard wall socket and be severely shocked. An aim of this invention is to mitigate and ultimately eliminate this shock hazard.

Part 2's electrical interconnection connects to standard electrical plugs or standard electrical wiring; Part 2's inductive coil presents a non-electrically energized surface to Part 1, where the two parts physically contact each other.

A characteristic of the preferred embodiment of the invention is that electrical interconnections are insulated where they cannot be touched by a person, especially a child. Another characteristic of the invention is that power is transferred from Part 1 to Part 2 by transformer action.

A preferred mode of the invention is where Part 1 and Part 2 are retained to each other using magnets.

In some embodiments Part 1 and Part 2 may be connected in more than one orientation, use other retention mechanisms, and/or include electronic sensing and/or control circuitry.

### DETAILED DESCRIPTION OF THE INVENTION

This invention includes at least two parts, Part 1 and Part 2, each of which contains an electrical interconnection and at least one inductive coil.

Part 1's electrical interconnection connects to standard electrical outlets or to electrical wiring; Part 1's inductive coil presents a non-electrically energized surface to which Part 2 can be physically attached. Part 1 is the equivalent of an electrical power outlet; yet it is an inductive power transfer outlet. Part 2 is the equivalent of an electrical power plug; yet it is an inductive power transfer plug. In a preferred embodiment of the invention Part 1 and Part 2 form an electrical transformer of independent parts joined to work as one to transfer power without exposed electrical contacts to touch or probe. Virtually every home in a household has wall outlets with exposed electrical connections that pose a danger to small children; a child can stick a conductive probe into a standard wall socket and be severely shocked. An aim of this invention is to mitigate and ultimately eliminate this shock hazard.

Part 2's electrical interconnection connects to standard electrical plugs or standard electrical wiring. When connected Part 2's inductive coil is capable of receiving energy inductively from Part 1. Energy is transferred from one part to another without exposed hot electrical interconnections.

A characteristic of the preferred embodiment of the invention is that electrical interconnections are insulated where they cannot be touched by a person, especially a child. Another characteristic of the invention is that power is transferred from Part 1 to Part 2 by transformer action or magnetic induction.

A preferred mode of the invention is where Part 1 and Part 2 are retained to each other using magnets.

Part 1 connects into standard electrical interconnects in standard ways, yet connects to and transfers power to standard electrical appliances/equipment through Part 2 by magnetic induction/transformer action.

Part 1 may be attached and retained by a variety of mechanisms into standard electrical interconnections or outlets.

In one embodiment:

Part 1 is designed to plug into a standard 110 volt household electrical socket using and may be retained in the wall socket by screws in standard locations, the same way that conventional household outlet socket frames are retained.

Male prongs extending from Part 1 when plugged into a standard female outlet are isolated from touching or probing as the metallic connections are shrouded or covered. The prongs also help to retain the Part 1 of the invention in place through friction even when not attached by other means.

Alternatively Part 1 may be connected to standard household wiring directly using standard female disconnect connectors. In one embodiment female disconnect connectors are crimped onto wires providing hot power, neutral, and/or ground; then the female disconnects are mated and electrically connected by pushing each appropriate male protrusion from Part 1 into the appropriate female disconnect connector.

In some embodiments Part 2 is designed to receive at least one conventional 110 volt plug from an electrical appliance such as a lamp, vacuum, television, or other electronic equipment. Simply plug the appliance's male metal prongs into female electrical receptacles in Part 2; the appliance plug may also be received within a small recess or be covered with a shroud. In these embodiments the recess or shroud prevents a thin probe like a butter knife from being able to contact the metal prongs from the appliance plugs.

In this embodiment Part 1 and Part 2 now have no exposed hot electrical connections, mitigating shock risk. When Part 1 and Part 2 are brought close to each other, magnets built within one or both parts grab and retain the parts together; to release simply rotate Part 2.

In other embodiments Part 1 and Part 2 may be connected in more than one orientation; for example orientation 1, and orientation 2: When the parts are in orientation 1, power will be transferred through inductive transformer action from Part 1 to Part 2, in orientation 2 power will not be transferred optimally or even at all from Part 1 to Part 2.

In this instance, sensors in Part 1 may also be used to switch on or off the inductive coil contained within Part 1 when in orientation 2. The switch when on creates a closed circuit in Part 1's coil (coil 1) and a voltage will be applied across the coil in Part 1 enabling current flow in coil 1. When the switch is off Part 1's coil, coil 1 will not have a complete circuit disabling the possibility of current flow through coil 1. These sensors or switches may be built from a separate sensor and switch combined or may be a made of a single sensor that also acts as a switch; in this disclosure the term “sensor switch” will be used to indicate either a separate sensor-switch combination, or a single sensor that also acts as a switch. A magnet in close proximity a sensor used to activate a switch is one possible embodiment.

The best mode of the invention covers or contains conventional electrical interconnections and provides inductive electrical energy transfer from one part to another; the best mode of this invention prevents children from electric shock because it prevents them from being able to stick probes into electrically hot electrical sockets.

In an alternate embodiments, circuits that sense the presence of a load control the amount of energy provided to power to the coil in Part 1. In one instance a thermistor provides high resistance when there is no load current; when load current increases thermistor temperature rises causing the resistance of the thermistor to reduce providing full voltage to the load. In other instances circuits capable of sensing the presence of a load are incorporated into the invention: such circuits are commercially available.

The invention may also include other safety features, such as a directly connected safety ground, high voltage dissipation diodes/lightning arrestors, and short circuit protection circuits.

Prongs protruding from Part 1 can make electrical connection with a standard wall outlet as prongs protruding from Part 1 are configured to plug into standard sockets or outlets directly.

In at least one other embodiment electrical wires in a building may easily be adapted to connect to the prongs protruding from Part 1; simply crimp female disconnects onto wires and slip the female end over corresponding prongs on Part 1, and then screw Part 1 into the enclosure of an outlet using standard screws.

The invention may also include a directly connected safety ground; which is an earth ground connection from the wall socket brought through Part 1 that contacts an electrically conductive contact on Part 2. The third prong on household electrical outlets is defined as earth ground in building codes; an earth ground provides protection against miss-wiring in an appliance that can cause electric shock.

### DESCRIPTION OF THE MANY VIEWS OF THE DRAWINGS

FIG. 1 shows an embodiment of the invention that includes a Part 1, shown as item P1, Part 1 is designed to electrically connect to a standard household Wall Outlet, item WO. Part 1, item P1 also connects to Part 2, shown as items P2A and P2B.

Two different standard plugs, items PL1 and PL2, are plugs from standard household appliances. These plugs, items PL1 and PL2 are designed to plug into Items P2A and P2B.

Item FP is a face plate that fits over standard household electrical outlets, it's a cover used in virtually every power outlet. The invention's Part 1, item P1 can be connected to a standard wall outlet whether a standard face plate is installed or not.

Item W is the wall to which a electrical wall outlet is attached.

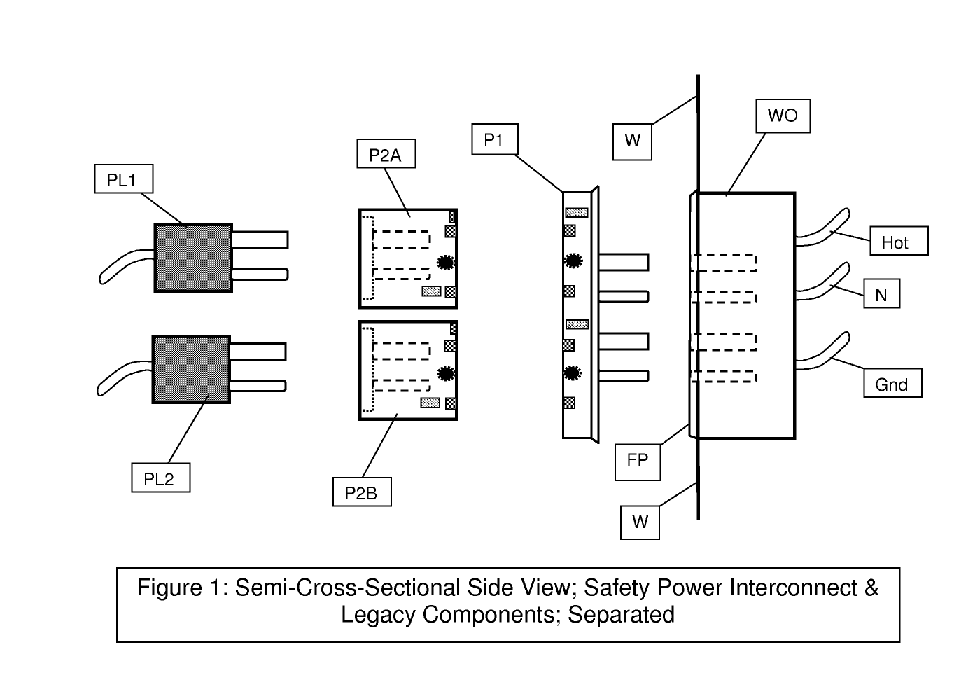

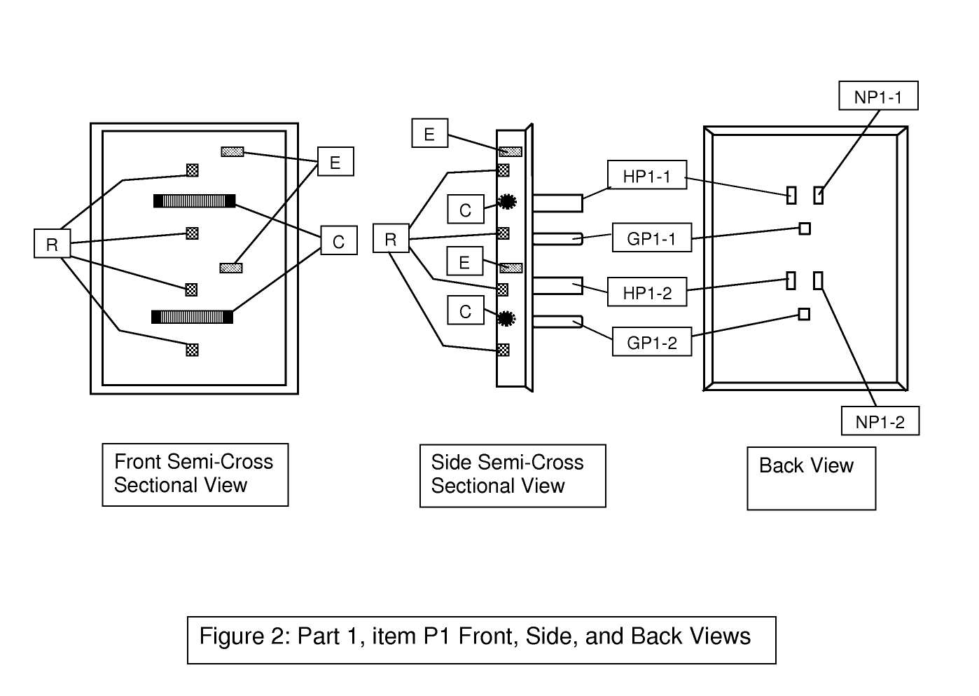

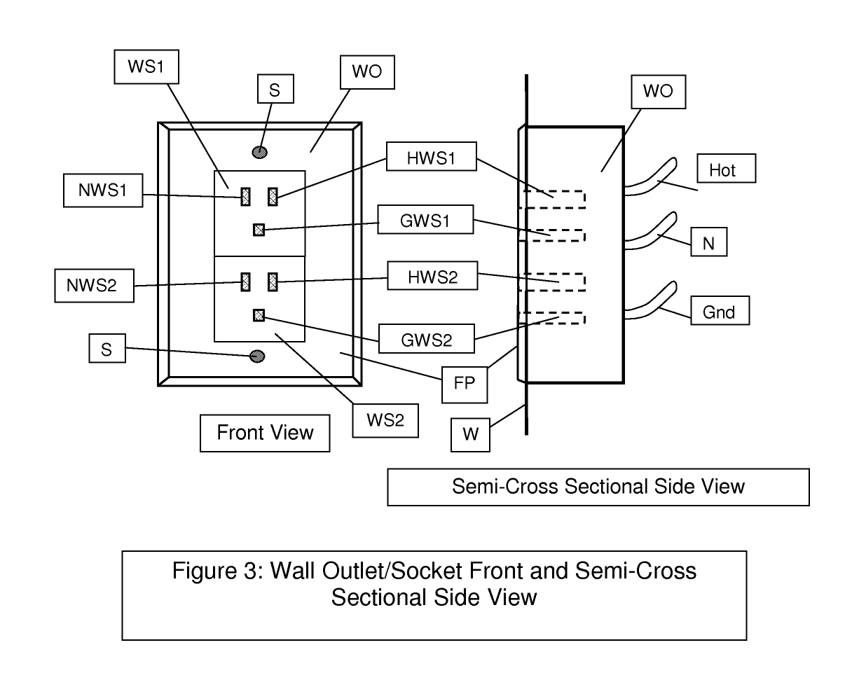

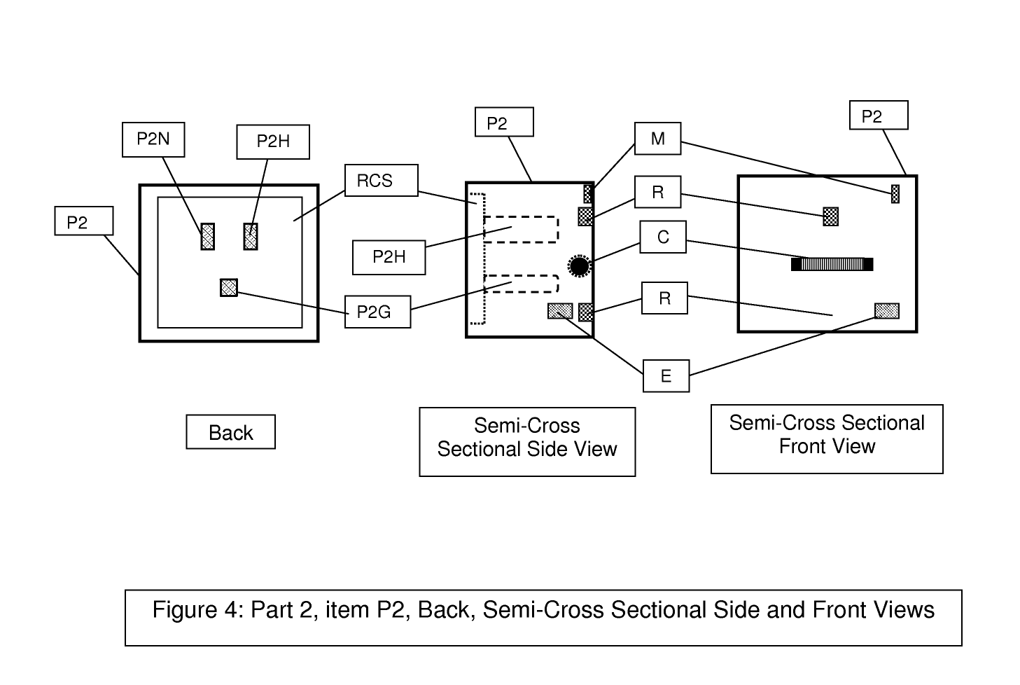

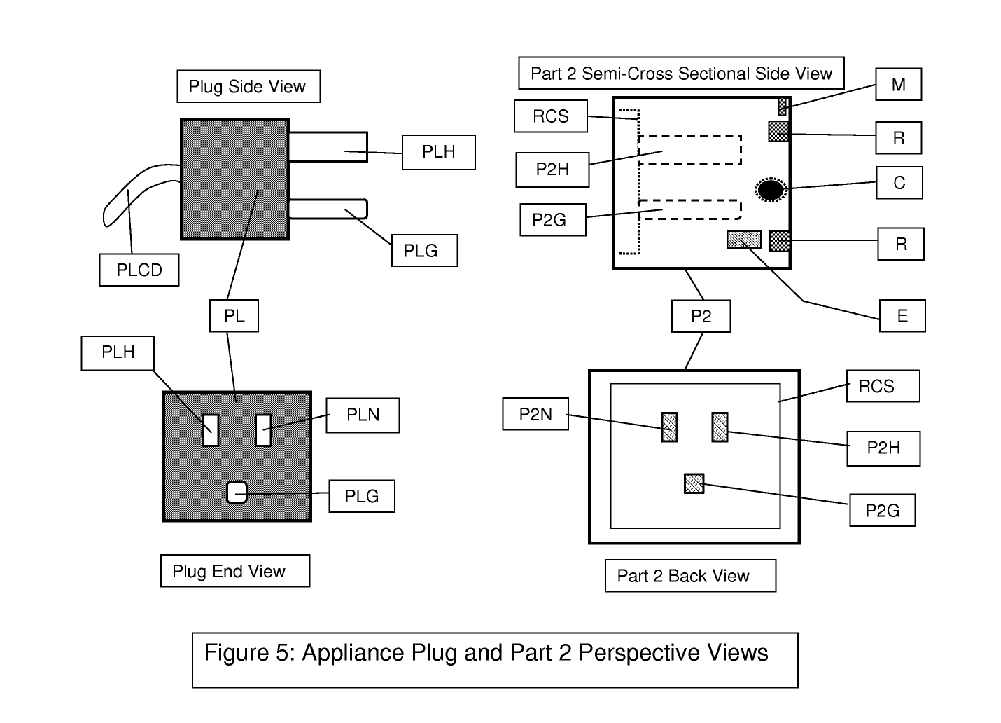

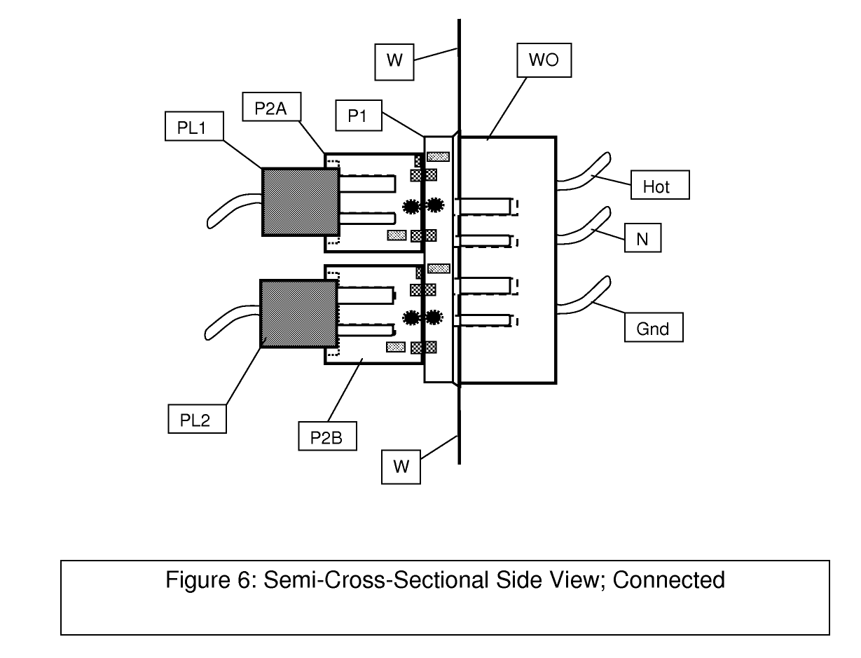

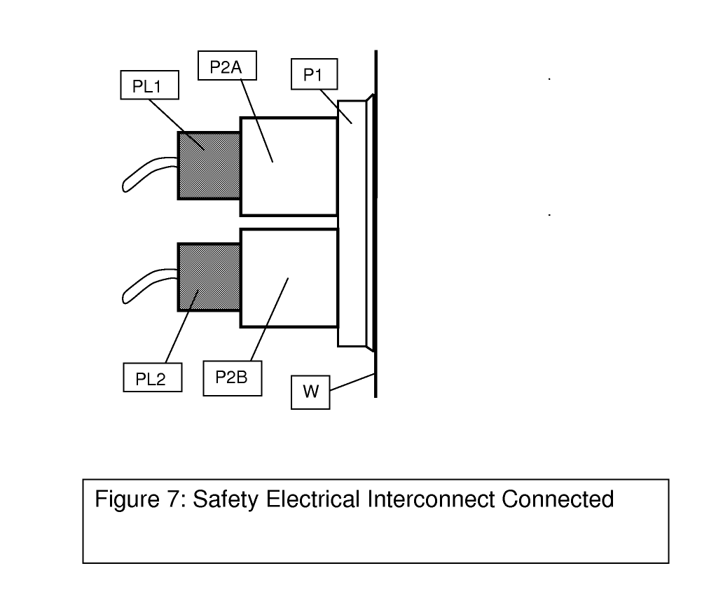

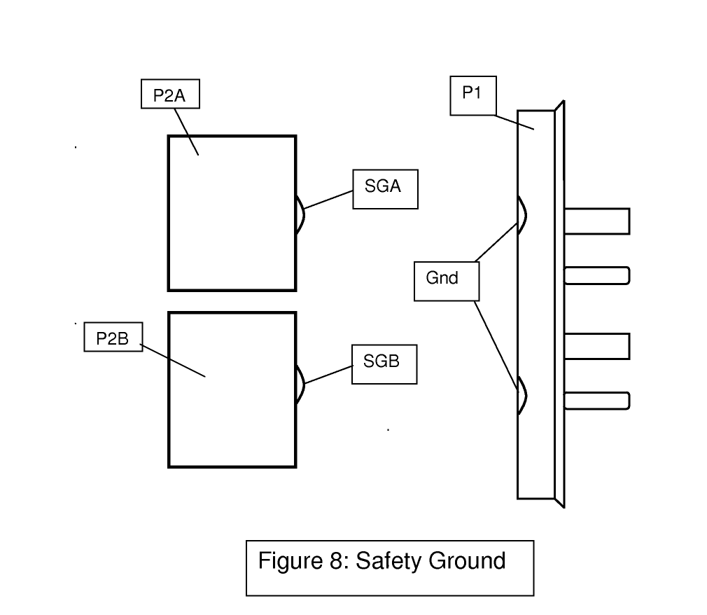

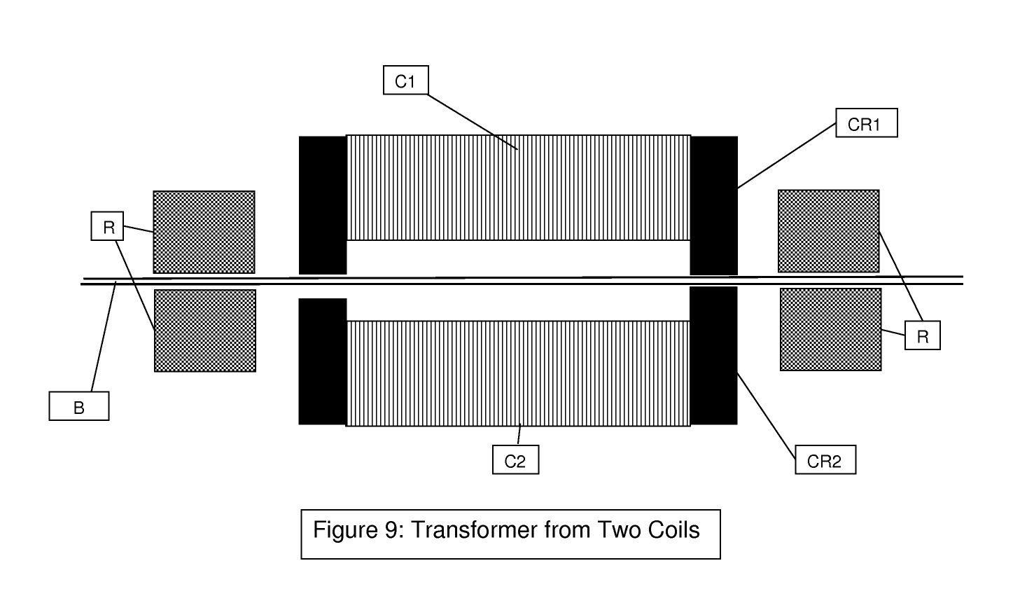

Also shown in FIG. 1 are standard household wires; item Hot is the hot wire, the wire energized with electrical energy, item N is the standard neutral wire, and item Gnd is Earth ground.

Items P1, P2A, P2B, and WO are depicted in Semi-Cross-Sectional views showing smaller parts internal to Items P1, P2A, P2B, and WO; these smaller parts are described in other figures, they are depicted here to add perspective and to show that components are included in the invention. All parts depicted are described in detail in drawings that follow.

FIG. 2 shows Part 1, item P1 Front, Side, and Back Views. The Front and Side Views are Semi-Cross Section Views; the Back view is not shown in cross section.

Items R are retention magnets or metal pieces built inside of Part 1; they are used to magnetically connect Part 1 to Part 2. Part 2 is not depicted in FIG. 2.

Items E are electronic circuits and/or sensors built inside of Part 1.

Items C are two coils, each with a metallic core. When Part 2 is connected to Part 1 a complete transformer will be formed.

Items NP1-1, GP1-1, HP1-1, NP1-2, GP1-2, and HP1-2 are electrically conductive pins like the male pins/prongs used in plugs that connect household appliances to wall outlets/sockets. These pins/prongs plug into standard power outlets and make electrical connections with two different electrical sockets from a single outlet; each socket has a neutral, an Earth ground, and a hot pin. For socket 1, item NP1-1 is the neutral pin, item GP1-1 is the Earth ground, item HP1-1 is the hot pin; For socket 2, item NP1-2 is the neutral pin, item GP1-2 is the Earth ground, item HP1-1 is the hot pin.

FIG. 3 shows a standard Wall Outlet/Socket, Front and Semi-Cross Sectional Side View.

Item WO is a standard household wall outlet that contains two wall sockets, wall socket 1 and wall socket 2, items WS1 and WS2. Each socket has a neutral, an Earth Ground, and a hot female electrical connection where standard appliances or applicant's invention Part 1 may be plugged into.

Item NWS1 is the neutral connection, item GWS1 is the Earth ground connection, and item HWS1 is hot connection for wall socket 1, WS1.

Item NWS2 is the neutral connection, item GWS2 is the Earth ground connection, and item HWS2 is hot connection for wall socket 2, WS2.

The dashed lines, labeled HWS1, GWS1, HWS2, and GWS2 shown in the Semi-Cross Sectional Side View depict part of the internal structure of the wall socket they are electrical receptacles in the wall outlet, WO.

Items S are screws or screw holes for mounting standard faceplates, item FP onto the wall outlet, WO.

The wall outlet also is connected to standard household electrical wiring, item N is the neutral wire, item Gnd is Earth ground wire, item Hot is the hot wire.

Item W is the wall.

12

FIG. 4 shows Part 2, item P2 in three different orientations: Back, Semi-Cross Sectional Side and Front Views.

Item P2N is a female receptacle of a neutral or virtual neutral electrical connection to an appliances plug, item P2H is a hot female receptacle electrical connection to an appliance plug, and item P2G is an Earth ground or a virtual ground connection to an appliance plug.

Item M is a magnet who's magnetic filed may be sensed by electronics in Part 1 or by a magnetic switch in Part 1; “a magnetic sensing system switch”. Part 1 is not depicted in FIG. 4.

Items R are retention magnets or metal used to connect Part 2 to Part 1.

Item C is a coil that forms ½ of a transformer when Part 2 is connected to Part 1.

Item E are electronics contained within Part 2, item P2.

FIG. 5: Appliance Plug and Part 2 Perspective Views shows a 3 pronged household appliance plug, item PL, and a the invention's Part 2, item P2.

Two perspective views of the plug, item PL are shown: a side view (Plug Side View) and an end view (Plug End View); item PLCD is the plug cord, item PLH is the hot plug male prong; item PLN is the neutral male prong; and item PLG the male plug ground are shown.

Two perspective views of the invention's Part 2, item P2 are shown: a Semi-Cross Sectional Side View and Back View are shown. Item RCS is a recess in part 2, item P2; item P2N is a neutral or virtual neutral is a female receptacle ; P2H is Part 2's Hot or virtual hot, and item P2G is Part 2's ground or virtual ground.

Item M is a magnet who's magnetic filed may be sensed by electronics in Part 1 or by a magnetic switch in Part 1; “a magnetic sensing system switch”. Part 1 is not depicted in FIG. 4.

Items R are retention magnets or metal used to connect Part 2 to Part 1.

Item C is a coil that forms ½ of a transformer when Part 2 is connected to Part 1.

Item E are electronics contained within Part 2, item P2.

FIG. 6 shows a Semi-Cross-Sectional Side View invention when connected. Here Part 1, item P1 is connected to the wall outlet, items WO; item P1 is also connected to two separate Part 2s, items P2A and P2B.

Plug PL1 is connected to P2A (Part 2A) and plug PL2 is connected to P2B (Part 2B). Wall outlet WO is mounted on wall W. Electrical connections to the wall outlet WO are Hot, N (Neutral), and Gnd (Ground).

FIG. 7 shows a connected version of the invention as it would appear when connected.

Here also Plug PL1 is connected to P2A (Part 2A) and plug PL2 is connected to P2B (Part 2B), and W is the wall. Here however the wall outlet, and the Hot, N (Neutral), and Gnd (Ground) connections are not shown.

FIG. 8 shows two Part 2s, P2A (Part 2A), & P2B (Part 2B) each connect to item P1 (Part 1); P2A has a safety ground electrical contact SGA, P2B has a safety ground electrical contact SGB, and P1 (Part 1) has two ground connections Gnd.

SGA and SGB in FIG. 8 are electrical contacts that interface with ground connections Gnd on part P1 providing a safety ground to connected equipment. Safety would be enhanced as the cases/frames of equipment could be grounded to a known earth ground mitigating shock risk if an appliance had a hot connection shorted to its case/frame.

FIG. 9 shows one embodiment of a transformer made from two coils in close proximity to each other.

Coil C1 is wrapped around a core CR1, and coil C2 is wrapped around core CR2. If coil/core C1/CR1 are the primary side of the transformer then coil/core C2/CR2 form the secondary side of the transformer. Retention magnets or metal R are also shown. Item B is a boundary between the two coils. The invention is not limited to the precise coil and core configuration as depicted. The cores CR1 and CR2 in FIG. 9 are shaped like a U, ends of the U shaped cores when aligned increase the efficiency of the inductive coupling between each side of the transformer because the cores focus electro-magnetic energy directly from one core to the other.

1. A safety electrical interconnect comprising:
a. A plurality of electrically conductive prongs protruding from a first part configured to plug into an electrical socket or outlet; said first part also containing one or more coils;
b. one or more second parts configured to receive an electrical power plug or cord; said at least one second parts also containing at least one coil.
c. said first part configured to connect and be retained to one or more of said one or more second parts; and
d. said one or more coils from said first part capable of communicating electrical energy inductively to one or more coils within said one or more second parts.

2. Said first part and/or said one or more second parts of claim 1 further comprising one or more magnets and or metallic pieces are configured to connect and retain said one or more second parts to said first part.

3. Said first part and of claim 1 further comprising electronic components.

4. Said one or more second parts of claim 1 further comprising electronic components.

5. Said first part and said one or more second parts of claim 1 further comprising a safety ground connection configured to electrically connect at least one ground connection from an electrical socket or outlet to a ground connection on at least one plug connected to at least one of said one or more second parts; said ground connection also contacting said first part and at least one or said one or more second parts of claim 1.
